(19) United States
(12) Patent Application Publication
(10) Pub. No.: US 2007/0162923 A1
(43) Pub. Date: Jul. 12, 2007

(54) Television audience measurement system and method

(75) Inventor: Luiz Antonio Silveira Da Motta, Sao Paulo (BR)

Correspondence Address: LADAS & PARRY, 26 WEST 61ST STREET, NEW YORK, NY, 10023, US

(73) Assignee: IBOPE PESQUISA DE MIDIA LTDA

(21) Appl. No.: 11/600,337

(22) Filed: Nov. 14, 2006

Related U.S. Application Data
(63) Continuation-in-part of application No. PCT/BR05/00083, filed on May 16, 2005.

(30) Foreign Application Priority Data
May 14, 2004 (BR) PI0401757-9

(51) Int. Cl. H04H 9/00; H04N 7/16

(52) U.S. Cl. 725/14; 725/10; 725/9; 725/62; 725/15

(57) ABSTRACT

This invention refers to a system and a method of television audience measurements in real time through analysis of the content transmitted by the television broadcasting stations. The system hereby proposed includes a medium of detection of change of tuning state (2) of a television set (1), a means of generation of subscriptions (3) that generates subscriptions containing information on the content emitted by the television set obtained from the detection of change in the tuning state of the television set (1), a management device (30), a means of remittance of subscriptions (4) and an audience central, wherein the medium of remittance of subscriptions (4) sends the subscriptions generated by the medium of generation of subscriptions (3) to the audience central every time the said medium of detection (2) detects a change in the tuning state of the television set (1). This system is structurally simple and allows the measurement of television audience in real time quickly and at a relatively low cost. The method of the invention includes the stages of (a) detection of change of tuning state of a television set, (b) generation of subscriptions containing information on the tuning state of the television set obtained from the detection of change in the tuning state of the television set, (c) management and remittance of the subscriptions to an audience central, (d) comparison of the information contained in the subscriptions sent to the audience central with the information recorded in the audience central referring to the transported broadcasting stations and (e) identification of the broadcasting station that was being viewed at the moment of the generation of the subscriptions. The continuous repetition of stages (a) to (e) every time a change is detected in the tuning state of the television set (1), allows a monitoring in real time of the audiences measured for every one of the broadcasting stations transported to the audience central.

This invention refers to a system and a method of television audience measurement in real time, which are used preferentially, by cellular telephone telecommunications networks for reception, processing and remittance of audience information to the clients of the service.

### FIELD OF THE INVENTION AND DESCRIPTION OF THE STATE OF THE TECHNIQUE

Initially, it is necessary to consider a series of fundamental elements so that it is possible to understand the system and the method of television audience objects of this invention.

a. Rating/Audience Concept

The numbers relative to “rating” or “television audience” have several meanings. In general, they refer to the estimates, in percentage or in absolute numbers, of the number of homes, television sets or persons that view or are exposed to the content transmitted by the broadcasting stations of the television programs. In the case of this document, we use the expression “television audience” or simply “audience” in reference to the estimates of the numbers of people/television sets turned off or turned on in a broadcasting station.

There are currently innumerous techniques of television audience measurement, which use different measurement systems to detect which channels are being transported through a determined sample of television sets.

Generically, you can say that the currently known systems for audience measurement are formed by devices that register what is being received in every television set and transmit the registers to a collection central equipped with equipments, which interprets what was registered, identifying which broadcasting stations were tuned by every television set, when and for how long.

The audience estimates of the television broadcasting stations are investigated continuously and with the aid of registers especially designed for this purpose.

Thus in order to proceed, it is necessary to identify the Tuning State of the current television sets (turned on/turned off device and tuned broadcasting station), at a determined instant or interval before calculating what portion of the audience will fit to this or that broadcasting station.

b. Identification Techniques

b1. Identification of the Tuned Channel

So as to define the tuning state, some parameters of the television set used to be measured, such as, for example, the angular position of the rotating channel selector present in the old television sets, the energy of any part of the circuit that is associated to the turned off TV state, the voltage applied to the variable capacitance diode of the TV receptor, the frequency value radiated by the local oscillator circuit, the interpretation of the commands ordered to the television set by means of monitoring of the transmissions of the remote control and/or the monitoring of the panel buttons, of the displays and of the information presented on the screen.

b2. Channel State Detection

Another relevant information used for this invention is the indication that there was a change in the tuned channel through the monitored television set.

The change of state can be detected through diverse currently used processes. On the part of the processes described below, some false positive identifications can occur. That is, the process can reveal the occurrence of a false change of state. This does not invalidate the process since these occurrences are sporadic. On the other hand, a false negative occurrence is unacceptable, that is, when there was, in fact, a change of state and the process did not detect it.

Prolapse of the Vertical

Conventional television sets, equipped with image tubes, radiate electromagnetic signals when they are in operation. The beginning of every image frame is always preceded by an unmistakable radiation associated to vertical synchronism pulse generation. These pulses are periodic but they suffer a temporary instability when the television set changes channel. This instability is known as Prolapse of the Vertical. The Prolapse of the Vertical always occurs in a change of channel, but also it can occur due to an interference that causes instability of the image, absence of carrying wave etc., generating therefore, false indications of change of channel. This does not invalidate its use, since normally they are sporadic accidents.

Infrared Activity

Detectors of activity of the infrared light emitted by the remote controls to generate commands to the domestic electronic devices in general also can be used in logical circuits designed to mark the occurrence of any change in the tuning state of the television set. A detector of this type will also be activated whenever the remote control activates the change of other non-monitored parameters of the television set like for example the audio volume, brightness of the image, color, etc., generating therefore a false positive indication of a change of channel. On the other hand, the change of tuned channel through the direct activation of the command buttons of the television set will imply in a false permanence indication in the same tuning status. This limitation does not invalidate the process as long as it assures, in some way, that this direct activation will not be used.

Standardized Images

Many television receptors respond to the commands of the users with known standard images designed on the screen of the television set. These images contain useful information for the people that are viewing TV and always appear when a change to a new channel is activated. Analyzing circuits of these standardized images can detect on the screen the occurrence of a change of channel characterizing then the event that delimits the beginning of a new period.

All abovementioned concepts will be important for the understanding of the invention and for the detection of the improvements attained by it with relation to the currently known systems and methods in the state of the technique. Besides this, having in mind that this invention uses some of the abovementioned concepts and technologies, the description above must be consulted whenever necessary for a better understanding of the system and method hereby proposed.

b3. Disadvantages of the Tuned Channel Identification

Although the identification of the channel tuned by the television set is still very used by the audience measurement systems, this method is being substituted by a new tendency that has emerged in the last decade, which includes the content analysis of the signals transmitted by the channels. This analysis allows the determination of the tuning state of the television set and is a valid solution to confront the increasing difficulty of installing sensors, many times invasive, in television receptors to measure the desired parameters, such as exemplified in the previous paragraph.

Currently, television reception, in the majority of the homes, is done by just 1 television set that by rule can be monitored through the simple sensor detection of some parameters like the ones described above (item b1—Tuned channel identification). Meanwhile, the difficulty of carrying out this task is increasing due to an also increasing number of variables that need to be measured. The modern receptors, as they become more and more complex each time, equipped with miniaturized circuits, impede the physical access to the monitoring points. The association of various tuners of TV signals multiply the difficulties in such a way that many times it is impossible or anti-economic to determine which channel was finally tuned and exhibited on the screen of the television set. In these cases the television reception can be done with the aid of an association of multiple devices such as video tuning/reproducing/recording devices associated to receptors/decoders of signals transmitted through cable and/or satellites. The receptors of digitally transmitted signals are equipments with a complexity more than sufficient to make unfeasible the use of sensors traditionally used until today.

Another disadvantage of the identification of the tuned channel is the need of having adaptation between the channel viewed by the viewer and its effective programming. This occurs then, in a determined city, a determined television channel can be transmitted, for example, as channel 5, while, in another city, this channel can be transmitted as channel 6 (therefore, in another frequency). In this manner, just based on the channel tuned by the television set (channel 5, in this example) it would not be possible to attribute correctly the audience to the corresponding broadcasting station.

So as to cure this limitation, previous programming is performed in every television set that will be monitored, in order to make possible the delimitation of which broadcasting station corresponds to every channel tuned in each one of them.

In case the viewer comes to make use of cable television channel receptions, for example, the reprogramming of the channels is obligatory, for the purpose of making possible the continuity of audience follow-up. It is worth point out that the need of reprogramming increases operation maintenance costs of these television audience measurement systems of the state of the technique.

b4. Content Identification

In order to estimate the audiences reached using this new concept, it is enough to assure that the content, that is, the image and/or the audio present in every monitored television set, were emitted by this or that broadcasting station, wherein it does not matter how the television set had access to this content.

In order to simplify the process, most of the time the analyzed content consists of just the image or just the audio signal. These processes have reasonable and compatible assertiveness with the quality standard demanded by the market analysts of the entertainment industry.

Currently, it is observed the use of diverse techniques that follow this concept, some of which will be described as follows:

Identification of Coded Content

In this case, the transmitted content contains a code that identifies it and that it is detected every time this content is seen/heard in the monitored area.

Identification is possible when a code is added, of unperceivable preference, to the content transmitted by the broadcasting station. The code contains the identification of the broadcasting station besides other additional information. The audience register, in this case, detects this code, registers its occurrence, and indirectly indicates which broadcasting station was identified in the television set of the monitored area.

Identification of Content Through Comparison

The content exhibited by the monitored television set is compared with the content transmitted by the broadcasting stations to identify which of them generated the information that is being seen on the monitored receptor. This comparison can be local or centralized.

On local comparison, an additional receptor controlled by the audience register is used to tune the broadcasting stations. This control receptor is used in the search of a TV broadcasting station that is generating the same content as the monitored television set. The comparison of the contents can be performed continuously since both are present in the same area dispensing of the use of telecommunications resources.

On centralized comparison, the use of telecommunications resources is indispensable. In order to economize the use of these resources, the content exhibited by the television set is compressed before transmitting them to a collection central. The content is compressed drastically and transmitted to a central that in turn, compares it with the contents generated or just transmitted by the diverse broadcasting stations. In this process of comparison, it is identified which and when the broadcasting stations were tuned by the television sets in the monitored areas. However, in the centralized comparison, the information relative to the content reproduced by the television set or by the association of monitored receptors of television signals need to be robust, that is, they cannot be very compact to prevent the risk of non-identification.

Subscriptions

The concept of subscription must remain clear for a better understanding of the invention.

Subscription must be understood as a set of values that are calculated from the characteristics and properties extracted from the content of the information. It uses mathematical algorithms to calculate compact subscriptions (a lot smaller than the space occupied by the original information).

An audio or video signal can be digitalized and transformed into digital information. A subscription of an audio and/or video signal is a compact set of values that are associated in some way with the digital information that represents the original audio and/or video signal. A subscription is extracted from the signal that it represents. On the other hand, by rule, the represented signal cannot be generated from a subscription.

c. Registration of Data

The audience registers refer to the time periods in which the television set was turned off or on and in which channel(s) it was tuned to.

A period or segment of time remains perfectly characterized by two events, one at the beginning and another at the end. We define also that in a period, the tuning state of the monitored television set remains unaltered.

The audience measuring devices in general record the tuning states assumed by a television set in a format with fields in order to store the date and the time of the beginning and of the end of every period as well as the description of the tuning state of the monitored television set associated to this period.

There is an infinity of methods to determine the occurrence of a change of tuning state measuring electrical voltages, frequencies, etc., as previously mentioned.

d. Data Collection

After the stages of identification of the content and comparison, the registered audiences need to be transmitted to a processing central that calculates the audience estimates, produces and distributes the reports.

Normally, the audience registers store the collected data and transmit them daily to a central. In general, they transmit the registers carried out in the period initiated at the instant of the previous collection and finalized at the instant of the current collection.

The reports are periodic, produced with daily, weekly, monthly or any other desired frequency. The collection of this information is, in general, daily and performed at dawn. This information provides primarily the daily reports referring to the previous night.

However, there are some collection systems in real time, in which the information is transmitted as soon as the registers are done so that the processing central can calculate the audience estimates for the last minute.

The information used to be transported to a processing central through the public or private telecommunications networks. The public telephony networks are the ones more used by the research companies that perform daily collection.

The real time collections, in turn, use particular telecommunications networks, using wireless radio communicators and today begin to use the modern data transmission services and in particular the ones implanted in digital cellular telephone platforms.

The companies that carry out the audience estimate use intensely this resource to transmit the audience information collected in the investigated residences. The transmitted data are rated by connection time or by packets (data volume), independent of the time when such transmissions were performed.

e. Premises, Objectives and Needs of the Audience Measurement Systems

With relation to the desirable characteristics that an audience registration and measurement system must have, we can cite the following:

(i) The installation of the audience registration equipments must be discrete, that is, little invasive. The current pioneer solutions use registers equipped with easy installation sensors. The electrical voltage detectors, frequency meters, etc., are being substituted by microphones and image sensors, among others, which can be installed without violating the box of the television set and of its accessories.

(ii) The collected data must be sent quickly to the processing central. Real time collection is a desirable characteristic although it is not used in important markets of the world. The solutions supported in the complex telecommunications networks like the Internet are relatively recent and are not intensively used yet, in data collection, by the companies that perform the TV audience estimates.

(iii) The registering devices must have media of communicating readily the events observed in the monitored areas. The audience registering devices are not usually equipped yet with means to transmit data through the Internet. In more developed countries, data collection is transmitted, traditionally, through telephone lines available in all their homes a long time ago and the collected data are transmitted at dawn of the following day. In Brazil and in many other countries in development, the data are transmitted through cellular telephones.

(iv) The use of electrical connections must be minimized. The lesser physical connections exist the better. Telephone lines present a good relation between operational cost and performance, however its installation is relatively complicated and invasive. The audience register, in general, is connected physically to a telephone line so as to be apt for transmitting their data.

(v) In countries equipped with deficient fixed telephone infrastructure, exclusive cellular telephones are successfully used for the transmissions of data collected by the audience registering devices.

(vi) The collected data volume must be the least possible for economy of time and of expenses with communications. The audience monitoring and collection systems in use were developed in a time where the time consumed in communications was rated. Today, telecommunications services providers are changing its business model and are rating the volume of data transmitted. It deals with the rating by packets of data. This new approach privileges the systems that function in real time that are transmitting their data as they are collected, such that it does not matter whether this is done sporadically or not, for just 1 minute or for 24 hours a day.

(vii) The registers can no longer be associated strongly to a date and time of transmission in an increasing number of areas, once the television exhibitions can be recorded and reproduces at any time. Only a small part of the people are used to viewing television in this manner, but there is a tendency of increase of this habit. It is expected that the technology embarked in the more modern television devices pressure an increase in the occurrence of these habits.

(viii) The audience registers must be compact to economize the time of transmission and principally the cost, once the telecommunications networks rate more and more packets of data every time. It is usual the adoption of descriptive process of events associated to the periods where the television sets remain tuned at the same broadcasting station. The audience registers format their information in registers that described a period of time where the observed television set remain unaltered at the same state (status). The beginning and the end of these periods remain characterize at the instant where a change in the tuning state associated to the said period occurs.

Besides the previously mentioned points, having in mind the high cost of implantation of the register for the measurement of television audiences and the complexity for the installation of the devices equal or similar to this at the home of the collaborators, it verifies a need each time greater in the development of systems and methods that are capable of measuring the television audience that use more advanced technologies, practical, fast, economical and of easy installation.

As relevant previous techniques of this invention, three North American patent documents can be cited, namely, U.S. Pat. No. 4,574,304, U.S. Pat. No. 5,023,929 and US 2002/0078441, described as follows.

The North American U.S. Pat. No. 4,574,304 reveals an audience measurement system for a television set connected to a video recorder capable of detecting the operation mode of the video recorder, to determine the reception channel and to allow the obtaining of data in the operation modes of the video. This system allows the audience of a television set to measure even when the viewer is not viewing a determined program in real time, that is, it allows the audience detection for a determined channel when a determined program is being recorded with the television turned off.

This system increases the scope of the events considered by the audience measurement systems, once it makes possible the audience registration for a determined channel even when the television is in its turned off state, as long as there is the register that the referred program is being recorded. This situation proves the intention of a viewer in viewing the determined channel at determined day and time. This intention can be considered in the audience statistics performed by some companies. On the other hand this patent reveals the preoccupation of registering what is viewed on the television through video reproductions and of registering the programs that are viewed outside the time of transmission. This mode of viewing television can also be identified in this invention.

The document U.S. Pat. No. 5,023,929 reveals a method for audience measurement that includes the recording of a plurality of audio signals from each one of the benefited localities that correspond to the audio signals of the signal broadcasting stations, synchronized with the recording of the programs that are being transmitted. The two recordings are then confronted aiming at obtaining the audience.

Therefore, the audience measurement method and system described in the U.S. Pat. No. 5,023,929 does not allow audience measurement without the need of recording of the audio signals.

The request of North American patent US 2002/0078441 reveals an audience measurement system in real time. However, the system is complex and needs an equipment called Set Top Box (STB) for the collection of the information of every television set. In the system described in this request of patent, the STB equipments must be connected to the television device and the connectors of telephone line or other means of data transmission so that it may be possible audience measurement in real time.

All the methods and systems above are capable of providing data with relation to the audience of different channels. However, it must be noted that none of the systems above allow the transmission of the audience registers to be managed and performed by a cellular telephone device in real time.

Besides this, the systems of the previous technique are complex and, majority, need a register or similar equipment where the collected information are recorded so that they can be compared afterwards with the information transmitted by the broadcasting stations and it may be possible the identification of the channel that was being viewed.

Having in mind that the dispute in the television market is found currently more and more intransigent, particularly in Brazil, it verifies a concrete need in the development of methods and systems that are capable of providing this information to the broadcasting stations in real time with the greater possible speed.

f. Concept of the Invention

Content: They are TV programs, commercials, vignettes, etc., exhibited by a television set;

Information Provider: They are broadcasting stations, producers, etc., that produce the contents;

TV Broadcasting Stations: They are the content diffusers (produced internally or provided by third parties).;

Collaborators: They are the people that reside in a home participating from the research panel and that are exposed to the content transmitted by television;

Registered Content: They are the audible and/or visual characteristics associated to a television set that are registered by the invention;

Subscription: Digitalized and compacted registered content;

### OBJECTIVES OF THE INVENTION

This invention has for objective to provide a television audience measurement method based on the analysis of the content viewed by the Collaborators.

A second objective of this invention is to provide an audience measurement system that uses the cellular telephone technology for the purpose of providing a rapid and reliable transmission of the subscription to an audience central.

This invention still has the objective of providing an audience measurement system that is economically viable and that, in virtue of this, it can be installed in a greater number of homes so as to increase the sampling group and, consequently, provide improved results with relation to the audience of the diverse broadcasting stations and/or information providers.

A fourth objective of this invention is to provide a television audience measurement system that, immediately after the reception of the subscription sent through the cellular telephone to the collection central, it can generate reports including the information and statistics referring to the registered audiences for the respective channels.

Consequently, it is still an objective of this invention to provide information to help the television broadcasting stations in the definition of their strategies and of their programming schedules, In other words, this invention aims to provide improved data with relation to the registered audience for all the broadcasting stations so as to allow them to negotiate propaganda and publicity contracts.

It is still another objective of this invention to provide a television audience measurement system that presents a simple structural comparison and that can be installed in any television device. Besides this, the invention has the objective of providing an audience measurement system whose installation is discrete, less invasive and that does not need to be electrically connected to the television set.

This invention has still the objective of providing an audience measurement method in real time using preferentially, the cellular telephone technology.

Still, the identification and measuring of the content audience is an important objective of this invention. The technology of the entertainment industry is improving to facilitate content consumption at the most adequate instant for every consumer. As such, the importance of the audience of a broadcasting station in determined time could decrease if the prerecorded content offer is of easy access and at the same cost. Then, the audiences of the programs no longer depend on the time in which they were viewed.

For the purpose of this invention, they will be considered only a subset of the possible states assumed by a television set, that is, it will be considered only the channel tuned by the monitored television set.

### BRIEF DESCRIPTION OF THE INVENTION

The objectives of this invention are attained through a television audience measurement system, particularly for the measurement of audience of at least one television set, including a medium of detection of change of tuning state of the television set, an information processing device, for at least a medium of remittance of subscriptions in the form of a cellular telephone and at least an audience central, the audience central continuously registering and recording subscriptions, the system still including a medium of generation of subscriptions that generates subscriptions containing information on the content emitted by the television set, and the medium of remittance of subscriptions sends in real time the subscriptions generated through the medium of generation of subscriptions to the audience central every time the said medium of detection detects a change in the tuning state of the television set, the audience central comparing the subscriptions recorded and compacted therein with the subscription sending by the medium of remittance of subscriptions in real time.

Also, the objectives of the invention are attained through a television audience measurement system, particularly a system as defined above, for the monitoring of an user which watches television instead of a television set, including a medium of detection of change of tuning state of the television set, an information processing device, for at least a medium of remittance of subscriptions in the form of a cellular telephone and at least an audience central which continuously register and records subscriptions, wherein it generates and transmits periodically a subscription which can be compared with the equivalent subscription generated at the audience central.

Additionally, the objectives of this invention are attained through the television audience measurement system as defined in the previous paragraph, including a medium of remittance of subscriptions in the form of a cellular telephone.

The objectives of this invention are attained also through a television audience measurement method, including the stages of:

(a) detect the change of tuning state of a television set;

(b) generate subscriptions containing information on the tuning state of the television set based on the content of the tuned channel, the referred information is obtained from the detection of any characteristic resulting from the change of tuning state in the television set;

(c) manage and remit concomitantly the subscription to an audience central;

(d) compare the information contained in the subscriptions sent to the audience central with information recorded in the audience central referring to the controlled broadcasting stations, and

(e) identify interactively the broadcasting station that was being viewed at the moment of the generation of the subscriptions;

the stages (a) to (e) being repeated continuously in real time every time a change in the tuning state of the television set occurs.

When the television set is turned off it is characterized a particular sate that does not imply in the generation of a subscription since there is no registered content.

With relation to the detection of change of tuning state of the television set, this invention possesses detectors of change of state designed to indicate the alteration of the channel tuned by the television set.

On the preferred modality of this invention that will be described further on, the detector of change of tuning state of the television set is a sensor of prolapse of the vertical. However, other types of detectors can also be used, among others, a detector of activity of infrared and an analyzing circuit of standardized images. It still is necessary to note that, in plasma of liquid crystal displays, the prolapse of the vertical does not occur, which is a phenomenon just verified in conventional tube televisions.

Besides this, it must remain clear that the identification of the state (status) of the television, that is, if the TV is turned off/turned on can be done using electrical parameters present in the television receptors.

The alteration of the channel tuned by the television set triggers the subscription calculation process for the identification of the new registered content.

This invention also generates subscriptions containing information on the registered content aiming at sending them to an audience central.

A subscription of a sample of time (for example, around 5 seconds) of a determined viewed channel is extracted at first opportune moment. Then the subscription is sent to the processing central immediately after calculated and by means of packet transmission from a digital cellular telephone system. The date and time of the beginning of event is also sent in the same occasion. Thus it remains characterized in the processing central: the event of the beginning and the subscription of a stretch of the registered content that is happening in the monitored television set. The end of the current period will remain characterized when an event generated by a new change of the broadcasting station occurs.

For effects of this invention, audio and/or video subscription must be understood as a compact set of values that are being associated in some way with the information of the audio and/or video signal exhibited by the corresponding television set. Therefore, the generation of subscriptions process presupposes the compacting of this information. This compacting is important to reduce the time of transmission and principally to decrease the costs referring to data transmission.

Normally, the subscriptions generated by the medium of generation of subscriptions have approximately 1 Kbyte of information.

The processing central confronts the subscription of the sample of time, sent by the register of a determined television set, with the subscriptions extracted from all the controlled broadcasting stations at the same interval of time.

In case there is an indetermination, the processing central generates a new request, that is, a subscription of a new sample of time must be calculated and sent to better identify the status of the monitored television set in that period. This interaction is another exclusive characteristic of this invention that has seen that other systems that monitor content, up to this moment, do not send the subscriptions in real time. In other systems the subscriptions are compared, on the day or in the following week, after having ended the collection from all television sets of the sample, not having therefore, any possibility of collecting new subscriptions of periods already closed that by chance have not been perfectly identified.

### SUMMARIZED DESCRIPTION OF THE DESIGNS

This invention will be, as follows, more described in detail based on an example of execution represented in the designs. The figures show:

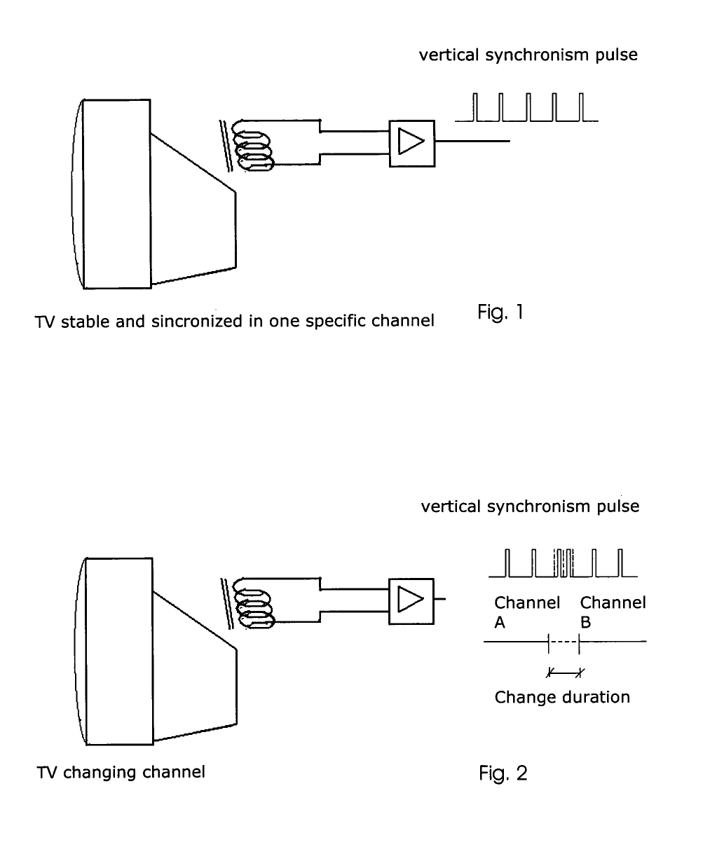

FIG. 1—It is an illustration of the vertical synchronism pulse when the television set is found in the stable and tuned state in a broadcasting station;

FIG. 2—It is an illustration of the vertical synchronism pulse when a change of channel (broadcasting station) occurs in the television set;

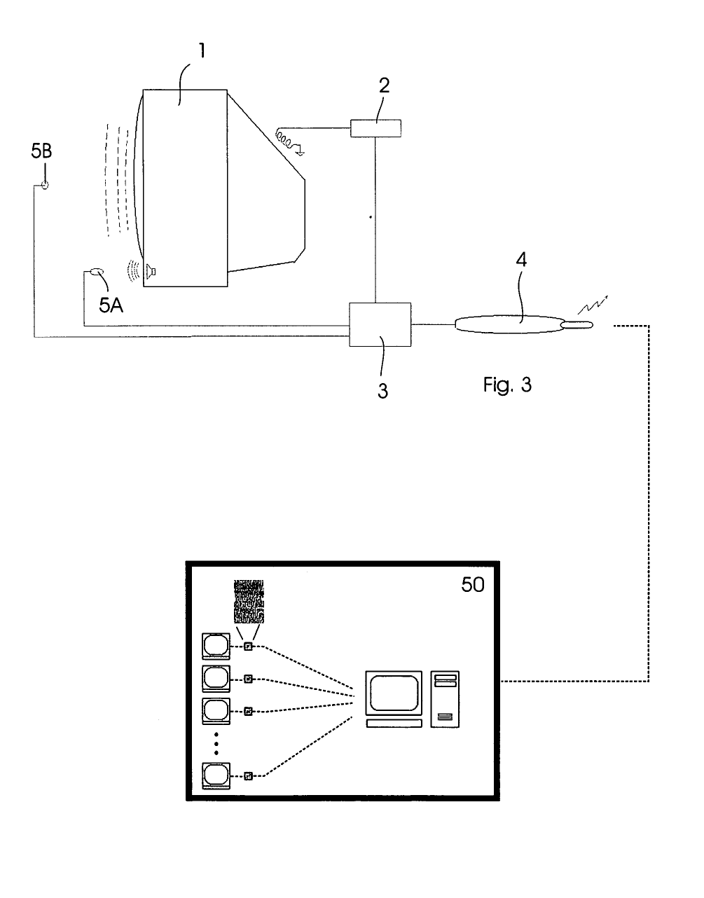

FIG. 3—illustrates a first preferred modality of the audience measurement system of this invention,

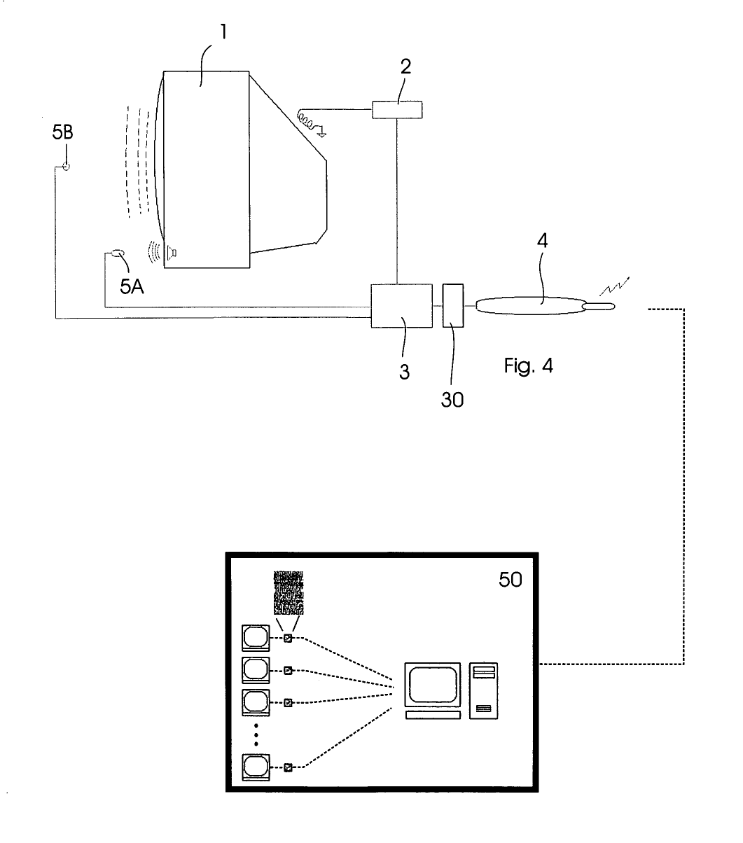

FIG. 4—illustrates a second preferred modality of the audience measurement system of this invention, and

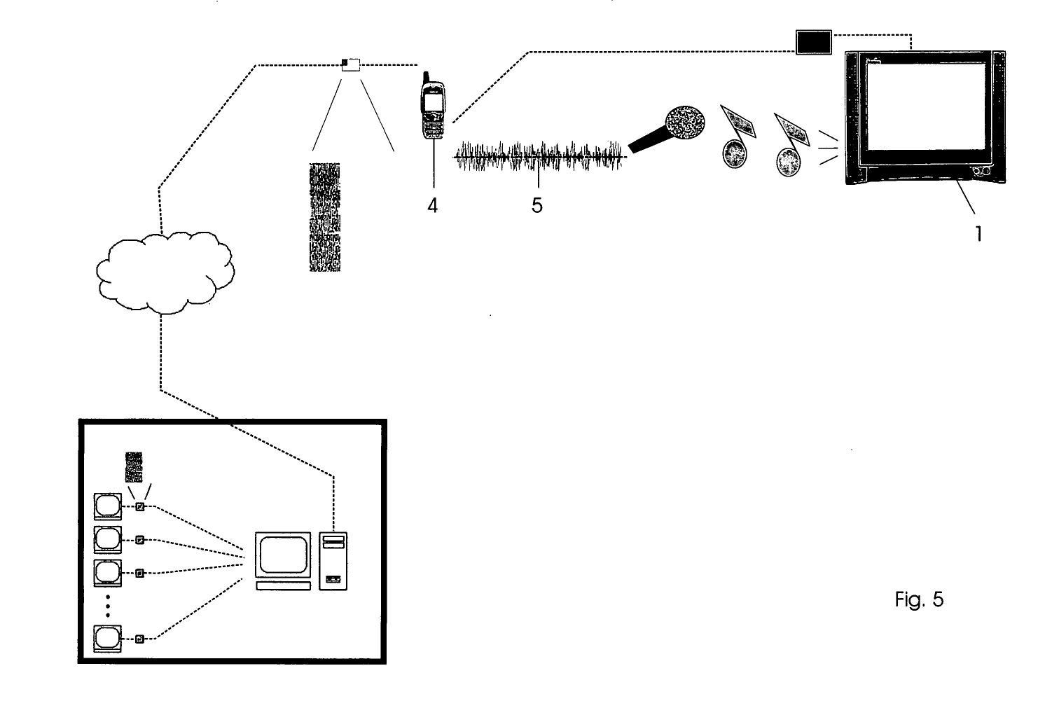

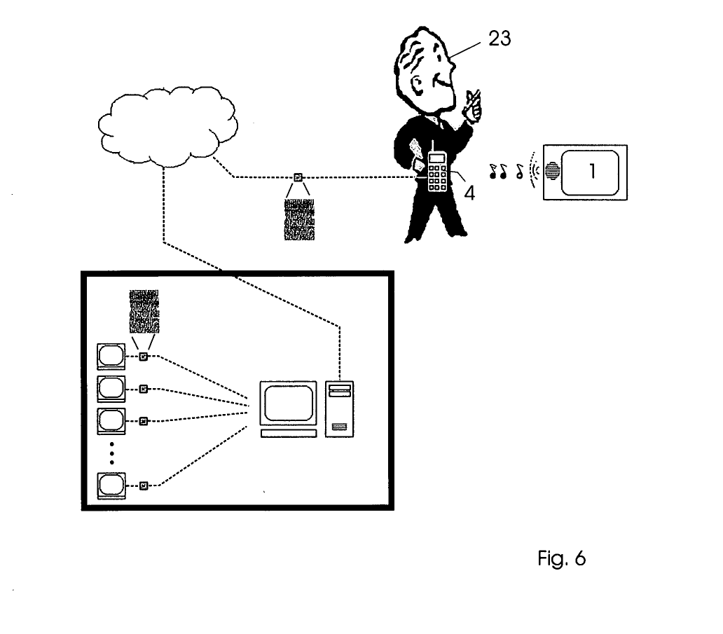

FIGS. 5 and 6—illustrates other modalities of the audience measurement system of this invention.

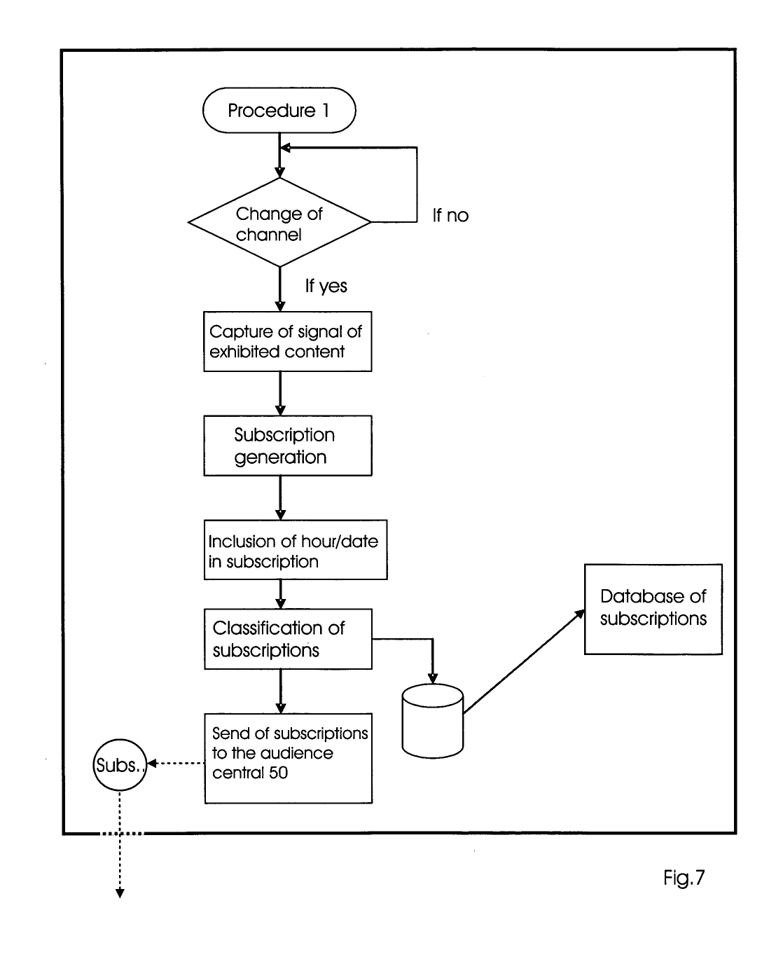

FIG. 7—illustrates a first procedure performed by operation routines of the audience measurement system of this invention, and

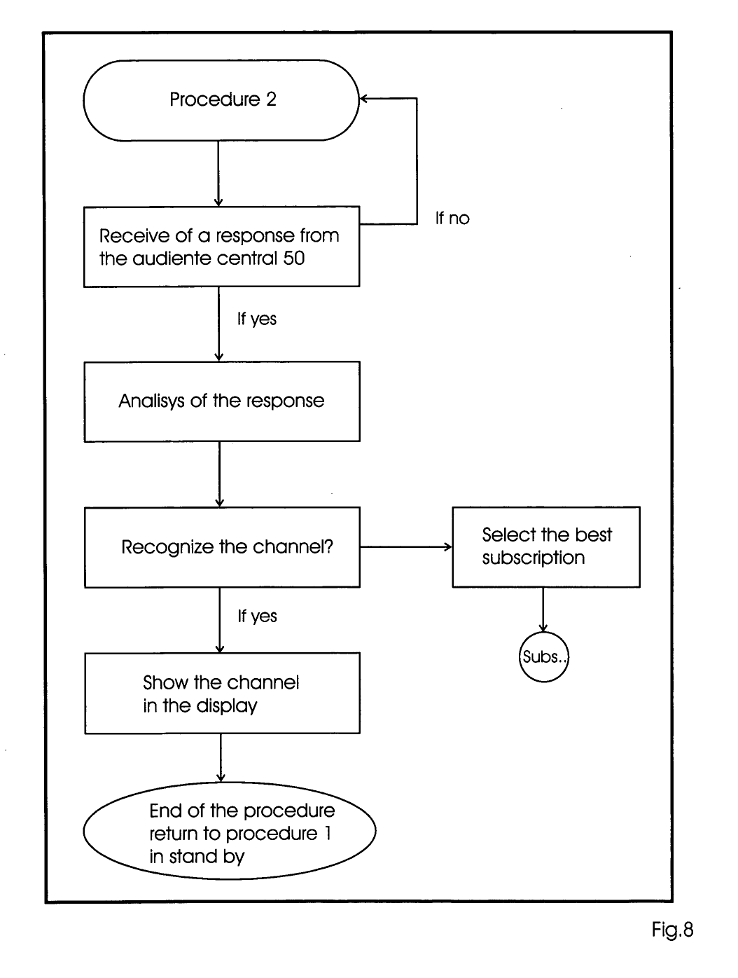

FIG. 8—illustrates a second procedure performed by operation routines of the audience measurement system of this invention.

### DETAILED DESCRIPTION OF THE FIGURES

FIGS. 1 and 2 illustrate the behavior of the vertical synchronism pulse every time a change of channel (broadcasting station) occurs in a tube television set. Analyzing these figures, it is perceived that the vertical synchronism pulse presents a regular behavior while the television set is found stable and tuned in a broadcasting station. On the other hand, as soon as the television set receives the command of change of channel (in this case change of the broadcasting station A for broadcasting station B), the pulse presents an instability, which receives the name of prolapse of the vertical. This instability occurs during a determined duration time until the television set is synchronized in the new channel B.

FIG. 3 illustrates a preferred modality of this invention and will be explained with details as follows. The preferred modality of the television audience measurement system of this invention includes a medium of detection of change of tuning state 2 of a television set 1, a medium of generation of subscriptions 3 that generates subscriptions from the content exhibited by the television set every time a detection of change in the tuning state of the television set 1 occurs, a medium of remittance 4 of subscriptions and an audience central 50, wherein the medium of remittance 4 of subscriptions sends the subscriptions generated by the medium of generation of subscriptions 3. The medium of generation of subscription 3 incorporates a managing equipment with processing capacity to manage the remittance of subscriptions.

In this preferred modality, the system includes still a sensor that detects audio and/or video signals 5A and/or 5B. The sensor can be only an audio 5A sensor such as a microphone or just a video 5B sensor such as a photosensitive cell. Still if desirable both sensors can be used together with the system of this invention. The sensors 5A and 5B transform acoustic and luminous signals in electrical signals that are analyzed by the generator of subscriptions 3. The most economical option proposed by this invention includes just an audio sensor, preferentially a microphone 5A, installed next to the speakers 6 of the television set 1. The use of just one audio sensor is possible due to the fact that audio signals already contain sufficient information in order that it may recognize the origin of the signals and, in this manner, determine which channel is being viewed in the great majority of the cases.

Still, there can be situations where the presence of a video signal turns safer the detection of the registered content, like for example in the case of programs where there are little sound signals present (transmission of a tennis match, for example), in case the television set is located in an environment with elevated noise level (what would make the generated audio subscription be contaminated with noise not relative to the transmitted channel) or even in the case of the user using the volume of the television set very low, close to the minimum, what would make difficult the capture of the audio signals on the part of the microphone 5A.

As illustrated in FIG. 3, the television audience measurement system does not need any physical electrical connection with the television set 1, which turns its installation a lot more practical and fast than the installation of the audience measurement systems currently known in the market, besides not being necessary to dismount the cover of the television set 1, which can be an inconvenience in case it is in the period of guaranty and can allure the antipathy and distrust of the user of the television set whose audience will be monitored.

On the preferential concretization, the medium of detection of change of tuning state 2 is preferentially a sensor of prolapse of the vertical, capable of detecting any change of the tuning state of the television set 1. These changes are caused by the change of channel or by the turning on and turning off actions of the television set 1. All these occurrences generate instability in the vertical synchronism pulse and, consequently, are detected by the sensor of prolapse of the vertical, allowing therefore that a change in the tuning state of the television set 1 be detected.

This detection occurs preferentially with the aid of an audio sensor 5A, which detects audio signals that are being received by the television set 1. As soon as the tuning state of the television set 1 is altered, the generator of subscriptions 3 makes use of the audio signals of the television set 1 received through the microphone 5A generating subscriptions based on detected audio signals. The generator of subscriptions is found connected and communicated to the detector of change of tuning state 2 of the television set 1, which automatically detects the occurrence of the change of tuning state. The detection of this change in the tuning state of the television set 1 activates the remittance of these subscriptions through the medium of remittance of subscriptions, which in this preferred modality is a cellular telephone 4, to the central audience, although other equipments can be used, like a cellular modem (which will be commented on further on), radio-transmitters, etc.

The management for the immediate remittance of the subscription corresponding to a change of tuned channel can be performed directly by the generator of subscriptions 3 (which in this case must possess the managing equipment with processing capacity to manage the remittance of subscriptions), through any specific managing equipment 30 (see FIG. 4) or even from any other manner that makes possible the correct operation of the invention.

One must have special attention with the location of the sensor so that the signals received by the television set can be easily detected. Thus, it is important that the sensor is always located in the field close to the broadcasting source of the signal. In case that the sensor is the microphone 5A, it must preferentially be located next to the speaker(s) of the television set 1.

While it must be understood that other audio sensors besides the microphone can also be used satisfactorily in the audience measurement system of this invention. For example, the audio signals can be captured and detected through an electrical coupling using the audio auxiliary output of the television set 1. The same audio signal is also radiated (electromagnetic emission) by the audio demodulation circuits. In this case a tuned circuit in the audio sub-carrier (4.5 MHz) can capture the audio of the broadcasting station tuned by the television set 1, even though it is with the sound volume totally cut (muting), eliminating some inconveniences mentioned above. Other types of sensors known in the technique can be used as long as they are capable of providing sufficient information for the calculation of the subscription, by the generator 3 of the audio signals detected by them.

As a rule, any alteration resulting from the change of the tuning state of the television set 1 generates at least a subscription on the content exhibited its tuning state.

Besides, although the preferred modality of this invention just uses an audio sensor, a video sensor can be used satisfactorily. Preferentially, the video sensor to be used is a simple sensor of luminance of the environment, just as a photosensitive cell 5B. The form how the light emitted by the image designed on the screen varies is a characteristic strongly associated to the exhibited content. Therefore, it can be easily identified the origin of the video signals captured by a sensor of video signals so that it can effectively register audience for a determined channel (broadcasting station).

Still making reference to FIG. 3, the audio signals transmitted by broadcasting station A that are being received by the television set 1 are detected by the microphone 5A. Based on these signals captured and detected by the sensor, the medium of generation of subscriptions (or generator of subscriptions) 3 generates audio subscriptions. For effects of this invention, it must be observed that the generator of subscriptions 3 used in the system hereby proposed is capable of generating audio and/or video subscriptions. The option for which type of subscription that will be generated will depend on type of signal that the sensor will be capable of detecting. In other words, if the sensor detects just audio signals among the signals received by the television set 1, then the generator of subscriptions 3 will generate just audio subscriptions. While if the sensor detects video signals, the generator of subscriptions 3 will be generating just video subscriptions. In a third possibility, if the sensor detects audio and video signals, the generator 3 will go generate audio and video subscriptions.

Returning to the description of the preferred modality of this invention, it is to be noted that, preferentially, upon installing the audience measurement system in the home of a collaborator, the cellular telephone is uncharacterized by being placed in a plastic box making it imperceptible (box not illustrated in FIG. 3). In place of the cellular telephone 4 a cellular modem can be used, which is nothing more than a cellular uncharacterized (with neither display nor keyboard).

Still with reference to the preferred modality of this invention, after the subscriptions are generated in the processor of the generator of subscriptions 3 (or of the specific managing equipment 30, if the generator of subscriptions does not have the capacity to manage the remittance of the subscriptions, according to FIG. 4), they are transmitted through the cellular telephone to an audience central 50. Arriving in this central (where all information referring to all monitored channels are compacted and stored constantly, which will be described in a more detailed manner further on), the information contained in the subscriptions sent by the cellular telephone are compared with the information recorded and compacted in the audience central so as to allow the identification of the origin of the signals that serve as base for the generation of the referred subscriptions. It must be noted that through the time of the remittance of the information sent by the telephone, it can be easily identified which broadcasting station was effectively tuned by the television set 1.

Therefore, this invention provides an audience measurement system in real time that presents a structural composition a lot simpler that of the systems currently known in the state of the art, which demand the physical installation in the television set.

FIG. 4 illustrates a second modality of this invention in which the managing equipment 30 for the remittance of subscriptions is provided separately from the processor of the generator of subscriptions 3, nevertheless, all the test of its operation is absolutely identical. It only deals with only a possible constructive variation.

In the television audience measurement system object of this invention, whichever may be its variables, audience central must be understood as a collection, processing and management central of the information referring to the viewed content or to the tuning state locally identified. It still must be noted that the identification of the broadcasting station that was being viewed is done through direct comparison between the information sent through the cellular and those that are found registered and recorded in the central. It is fitting to point out that during the entire time where the television sets 1 of the collaborators are being monitored, the audio and/or video signals of all channels controlled in the central 50 are being compresses, and, by analyzing the time of the remittance of the information by cellular, it is possible to compare the information recorded and compacted in the audience central with those sent by the cellular or similar. Thus it arrives at the channel that effectively was being viewed.

Besides this, the central is capable of generating reports based on the conclusions obtained from the comparison of the information sent by the cellular and recorded in the central and, in this manner, provide a panorama of the registered audiences for each one of the television broadcasting station connected to it.

It must remain clear, then, that although the medium of remittance of subscriptions must be preferentially a cellular telephone, the system proposed by this invention can function with a fixed telephone, as long as the line is available during the use of the audience measurement system.

In all the audience measurement systems described above, the detection of change in the tuning state of the television set occurs just after confirming the occurrence of a real change defined by the stability in the new tuning state. This is, if a user changes by mistake the channel of the television set (change of channel A to channel B) and returns to the old channel A immediately or if stays changing channel without fixing in anything, the detector of the prolapse will identify every change in the tuning state of the television set but in these cases, it is internationally accepted that these rapid changes of channel must not confer audience to any of the rapidly tuned channels. The change in the tuning state of the television set is only understood as such after a minimum period of time has elapsed within the supposed new tuning state. This period can be determined in accordance with the criteria of the rendering companies of this type of service. As an exemplificative title, this minimum period of time can be closely between 10 to 20 seconds and preferentially of 15 seconds.

In case there is any indetermination during the confrontation of the subscription sent by the cellular telephone to the audience central and the subscriptions extracted from all the broadcasting stations controlled by the central, a new request is generated by the processing central of the audience central 50. This is, a new subscription must be calculated and sent to better identify the state (status) of the monitored television set in that period. Therefore, it can be sent as smaller subscription standard (with lesser quantity of transmitted information) that, in case it is not clear due to its reduced size, another is rapidly generated, sent and compared.

Alternatively, telephone 4 programmable can be used, making possible the execution of an application through its internal processor (CPU). This application contains the whole functionality needed to make viable audience measurement and it can be installed and executed in the cellular telephone 4 at any time. In a preferential manner, the application uses Java programming language. In this case, the telephone itself can manage the remittance of the subscriptions to the central 50. In other words, the medium of generation of subscriptions 3 and the managing equipment 30 are part of the telephone cellular 4.

Preferentially, a single cellular telephone 4 device is used, but alternatively, two or more devices can be used if necessary or desirable.

The digital cellular telephones 4 possess data compacting mechanisms, which increase the efficiency in the transmission and reception of information corresponding to the conversation of its user with another speaker, text messages, images, diverse sounds, download of ring tones, music, etc.

Generically speaking, all information to be transmitted through a digital cellular telephone 4 is digitalized. In the case of audio information, the sound waves are transformed by the microphone in electrical impulses, which are digitalized internally in the telephone and transmitted as a set of binary signals (zero and one). To decrease the amount of information transmitted, compacting of this information occurs, that is, the digital information corresponding to the voice of the user that speaks on the telephone possesses a reduced size in order to be transmitted. However, this compacting is not very drastic since it is necessary to recover the original information without much loss (that is, it is necessary to recreate the language of the person so that the other speaker can understand it).

In the same manner, the cellular telephone receives digital information that were compacted at the central of the cellular telephone operator that must be converted again to voice so that the user can listen to the words of the speaker. Compacting is performed through the routines of the cellular telephone.

Due to this compacting of transmitted information, the voice of the person that speaks in a digital cellular telephone device is altered.

The now developed system makes use of an application, preferentially but not obligatorily, developed in Java language, which makes possible for the cellular telephone 4 device to perform a lot more drastic compacting of the signals received from the television set 1 (audio and/or video, as it will be mentioned further on), allowing the remittance of a small subscription, just sufficient to be compared with another subscription generated at the audience central.

Notwithstanding that mainly the television set 1 to be monitored is the one to which the cellular telephone device is associated (which will be described further on), it is possible to monitor any television set 1 that the monitored user 23 is viewing.

As already mentioned, subscriptions must be understood as a set of values that are calculated from the characteristics and properties extracted from the content of information. Mathematical algorithms are used to calculate compact subscriptions (a lot smaller than the space occupied by the original information). A subscription of an audio and/or video signal is a compact set of values that are associated in some way with the digital information that represents the original audio and/or video signal. A subscription is extracted from the signal that it represents.

The small subscription generated by the digital cellular telephone 4 device can not be transformed again into an audio and/or video signal similar to the one originally captured. Whatever the type of signal to be compacted may be, the whole processing capacity of the audience measurement system is performed by the processor of the cellular telephone device.

In the case of the first preferential concretization, the telephone 4 performs the compacting of the audio signals, which are collected preferentially through an external microphone, positioned close to the speakers of the television set, or, alternatively, through the proper internal microphone of the telephone 4 device, and transformed in electrical pulses. The telephone 4 then generates the first digital subscriptions corresponding to the information received whenever a change of tuning state occurs. The proper processor of the telephone 4 coordinates the remittance of the first subscriptions to the audience central, preferentially immediately after its generation, and still receives information from this central 50, as for example new subscription generation request for impossibility of comparing the one previously sent. In this case, the telephone 4 generates a new subscription from the new information captured and sends it to the central 50.

If the user 23 is monitored apart an specific TV set, the telephone 4 performs a procedure very similar to the to the described above, however it transmits periodically a subscription of the audio captured by its own microphone inasmuch as in this concretization it is not possible to determine the instants in which the changes in the tuning state of a possible television set occur. In case the monitored user 23 is viewing any TV device at the instant of the generation and transmission of a subscription (periodic event), the comparison with the equivalent subscription generated at the audience central 50 will be possible.

Still in an alternative manner, the compacting of video signals can be performed, acquired by means of an external luminance sensor, an external camera for the capture of images or even by means of the cameras that some cellular telephone 4 models possess incorporated.

Finally, a system in which the cellular telephone 4 device performs the compacting of the audio and video signals concomitantly can be anticipated.

With the execution of the compacting of information and consequent generation of the subscriptions by the proper cellular telephone 4 device, the use of an external subscription generation medium becomes unnecessary, which introduces a series of advantages to the improved system, which are:
Reduction of the cost of implantation of the system, due to the fact the external subscription generating equipment is no longer necessary;
Reduction of the volume occupied by the equipments, for the same reason;
Grater acceptance at the installation of the system on the part of the user, due to the reduction of the volume of equipments;
Reduction of the number of electrical connections, increasing the reliability of the system;
Possibility of monitoring of the audible messages and consequent generation of subscriptions received by a user carrier of the digital cellular telephone 4 device that is listening to the resonant content emitted by a tuned receptor in a broadcasting station, due to the minute size of a cellular telephone, without mentioning that a large number of persons already uses cellular telephones daily without thinking that this brings any type of discomfort.

Moreover, this invention provides a television audience measurement method, which includes the stages of:

(a) Detection of change of tuning state of a television set;

(b) generation of subscriptions containing information on the tuning state of the television set based on the content of the tuned channel, obtained from the detection of change in the tuning state in the television set;

(c) management and remittance concomitantly of the subscriptions to an audience central;

(d) comparison of the information contained in the subscriptions sent to the audience central with the information recorded in the audience referring to the controlled broadcasting station; and

(e) interactive identification of the broadcasting station at the moment of the generation of the subscriptions.

The stages (a) to (e) of the method above are repeated continuously every time a change in the tuning state of the television set occurs. When the television set is turned off it is characterized a particular state that does not imply in the generation of a subscription since there is no registered content.

Preferentially, a subscription is generated every time a change in the tuning state of the television set is detected, but in case it is not robust enough to make possible the identification of the viewed channel, another subscription is generated, and so on until the identification is possible.

If a telephone cellular programmable 4 is used, the subscriptions are generated by the proper phone 3, avoiding the necessity of the generator of subscriptions 3 and the specific managing equipment 30.

Stage (a) of the method described above includes, preferentially, the detection of the audio and/or video signals that are received by the television set. Besides this, stage (b) includes the generation of audio and/or video subscriptions based on the audio and/or video signals detected in stage (a), therefore based on the content of the tuned channel. In the preferred modality of this invention, stage (a) includes just the detection of the audio signals received by the television set and stage (b) includes just the generation of audio subscriptions. Still, it must be understood that stage (a) can include the detection of just audio signals, just video signals or both, depending on the type of sensor that will be used for the execution of the method. Consequently, stage (b) could include only the generation of audio subscriptions, only the generation of video subscriptions or the generation of audio and/or video subscriptions. It is only important that stage (b) of generation of subscriptions be performed based on audio and/or video signals detected in stage (a).

It says interactive identification in stage (e), once it is the collection central that identifies the viewed channel, from the subscription sent. In case the subscription is not sufficient to enable de identification, the central orders the telephone to generate the new subscription and send this new subscription generated so that it can identify the viewed channel. There is, therefore, interactivity between all these elements to make possible the verification of the audience.

As an advantage, the audience measurement system of this invention is capable of registering audience for a determined channel even when the collaborator does not view a determined program at the time when it was transmitted. This is, if a determined person records a program X that was transmitted by the broadcasting station A at 3 p.m. and views it only at 8 p.m., the central will identify which content of which broadcasting station coincides with the subscriptions generated by the monitored television set. In this manner, even though the program is not viewed in real time, there will always be the subscriptions of the broadcasting station that transmitted those texts/images/figures.

As already previously mentioned, another important aspect of the system proposed by this invention is that it can send as standard smaller subscriptions (with lesser amount of transmitted information) that, in case it is not clear due to its reduced size, another is rapidly generated, sent and compared.

Based on the description above accompanied by the designs, it can be verified that the system and the method of audience measurement of this invention, differently from the systems and methods currently known, are capable of providing the audience registers in real time every time a change of tuning state in the television set is detected with the analysis of the content of the tuned channel in a practical and quick manner. Moreover, the system hereby proposed does not need the use of conventional registering devices and, beside this, does not demand that the system be physically connected to the television set of the collaborator.

Still it must be noted that the costs of production, installation and operation of the audience measurement system of this invention are relatively low, and therefore, its use becomes viable in a bigger sampling group.

Finally, it is important to mention the operation routines or the like used by the cellular telephone 4 having processing means, which enables the small equipment to generate the subscriptions and send them to the central 50, as well as to receive from the central 50 the instructions for generating and sending another subscriptions.

In a first procedure, the operation routines (see FIG. 7) starts operating by detecting the change of channel of the TV set.

If the channel is not changed, nothing occurs since the actual channel is still being seen.

After a change in the channel (for example by the sensor of the prolapse of the vertical), the operation routines determines that the cellular captures the signal of the exhibited content, which is preferably an audio information. The audio information is captured by a microphone (part of the cellular or not).

After the capture of the signal, that is to say, after the microphone to convert the audio signal from a sound to electrical impulses, the processing means determine the generation of a compact subscription, as already mentioned. After the generation of the subscription, the operation routines inserts the information of hour/date, enabling the subscription to be compared to the subscriptions generated in the central 50.

After, the subscription is classified to be finally sent to the central 50.

The classification of the subscription is an optional step and is performed when it is desired to analyze it prior to its remittance to the central. As an example, the operation routines can determine the cellular phone to analyze a data base of subscription in case it has another signal indicative of audience. It can happens when the subscription has information about the logo of an specific broadcast.

When the sent subscription is not robust enough to be identified by the central 50, the latter send an order to the cellular 4 for the generation and remittance of another subscription. In this case, the first procedure of the operation routines occur until the channel is identified.

Another feature of the telephone cellular 4 having the present operation routines is the capacity of showing in its display the channel which is being view, in real time, after the recognition of the generated subscription by the central 50.

This feature is possible to be achieved by a second procedure performed by the operation routines which is schematically illustrated in FIG. 8.

In second procedure, after the recognition of the subscription generated by the central 50, it inform the cellular, which therefore receives from the central 50 an response or information about which channel is being seen.

The operation routines then analyses the response of the audience 50 and, if it can recognize the information about the channel, the telephone shows the name/number of the channel in the display.

If the information from the central 50 is not recognized by the cellular 4, the operation routines instructs the communication to the central for the remittance of another information to be recognized.

Having been described two examples of preferred concretization, it must be understood that the scope of this invention includes other possible variations; wherein it is limited only by the content of the attached claims hereby included the possible equivalents.

1. Television audience measurement system, particularly for the measurement of audience of at least one television set (1), including a medium of detection of change of tuning state (2) of the television set (1), an information processing device, for at least a medium of remittance of subscriptions (4) in the form of a cellular telephone and at least an audience central (50), the audience central (50) continuously registering and recording subscriptions, the system being characterized in that it still includes a medium of generation of subscriptions (3) that generates subscriptions containing information on the content emitted by the television set, and the medium of remittance of subscriptions (4) sends in real time the subscriptions generated through the medium of generation of subscriptions (3) to the audience central every time the said medium of detection (2) detects a change in the tuning state of the television set (1), the audience central comparing the subscriptions recorded and compacted therein with the subscription sending by the medium of remittance of subscriptions (4) in real time.

2. System in accordance with claim 1, characterized in that the medium of detection of change of tuning state (2) is a sensor of prolapse of the vertical.

3. System in accordance with claim 1, characterized in that it includes additionally a sensor (5A, 5B) that detects audio and/or video signals that are being received in a television set (1).

4. System in accordance with claim 3, characterized in that the sensor is a microphone (5A).

5. System in accordance with claim 4, characterized in that the microphone (5A) is located next to the speakers (6) of the television set (1).

6. System in accordance with claim 3, characterized in that the sensor is a photosensitive cell (5B).

7. System in accordance with claim 3, characterized in that the medium of generation of subscriptions (3) generates audio and/or video subscriptions based on audio and/or video signals emitted by the television set (12) and detected by the sensor (5A, 5B).

8. System in accordance with claim 1, characterized in that the medium of detection of change of tuning state (2) is a detector of activity of infrared light or an analyzing circuit of standardized images (5D).

9. System in accordance with claim 1, characterized in that the medium of generation of subscriptions (3) and the managing equipment (30) are part of the telephone cellular (4).

10. System in accordance with claim 1, characterized in that the medium of generation of subscriptions (3) possesses processing capacity to manage its remittance.

11. System in accordance with claim 1, characterized in that it possesses a specific managing equipment (30) with processing capacity to manage the remittance of subscriptions.

12. Television audience measurement method, characterized in that it includes the stages of
(a) detect the change of tuning state of a television set (I);
(b) generate subscriptions containing information on the tuning state of the television set (1) based on the content of the tuned channel, the referred information are obtained from the detection of any characteristic resulting from the change of tuning state in the television set (I);
(c) manage and remit concomitantly the subscriptions to an audience central;
(d) compare the information contained in the subscriptions sent to the audience central with the information recorded in the audience central (50) referring to the controlled broadcasting stations; and
(e) identify interactively the broadcasting station that was being viewed at the moment of the generation of the subscriptions;
the stages (a) to (e) being repeated continuously in real time every time a change in the tuning state of the television set occurs.

13. Television audience measurement method in accordance with claim 12, characterized in that the change in the tuning state of the television set (1) is caused by the turning on, turning off or changing the channel action of the television set.

14. Television audience measurement method in accordance with claim 12, characterized in that the stage (a) includes the detection of audio and/or video signals that are being emitted by the television set after the permanence of the television set in a tuning state for a predetermined and programmed period of time in a medium of detection of change of tuning state (2).

15. Television audience measurement method in accordance with claim 13, characterized in that stage (b) includes the generation of audio and/or video subscriptions, by the telephone cellular (4), based on the audio and/or video signals detected in stage (a).

16. Television audience measurement system, particularly a system as defined in claim 1, for the monitoring of an user (23) which watches television instead of a television set (1), including a medium of detection of change of tuning state (2) of the television set (1), an information processing device, for at least a medium of remittance of subscriptions (4) in the form of a cellular telephone and at least an audience central (50) which continuously register and records subscriptions, characterized in that it generates and transmits periodically a subscription which can be compared with the equivalent subscription generated at the audience central (50).

17. Television audience measurement system, particularly for the measurement of audience of at least one television set (1), including a medium of detection of change of tuning state (2) of the television set (1), an information processing device, for at least a medium of remittance of subscriptions (4) in the form of a cellular telephone and at least an audience central (50), the audience central (50) continuously registering and recording subscriptions, the system being characterized in that the telephone cellular has processing means and itself acts as a medium of generation of subscriptions (3) and includes operation routines or the like which operate in at least two working procedures, wherein at least one of the procedures includes the following steps:
(i) detecting the change of channel of the TV set;
(ii) the processing means determine the generation of a compact subscription;
(iii) insertion of information about hour/date in the generated subscription;
(iv) remittance of the subscription to the audience central (50).

18. A system according to claim 17, characterized in that, during the step (i), the cellular (4) captures the signal of the exhibited content, which is preferably an audio information.

19. A system according to claim 18, characterized in that the audio information is captured by a microphone which is part of the cellular or not.

20. A system according to claim 17, characterized in that, after the generation of the subscription, the operation routines of the cellular telephone 4 enable the subscription to be compared to the subscriptions generated in the central 50.

21. A system according to claim 17, characterized in that the classification of the subscription is an optional step and is performed when it is desired to analyze it prior to its remittance to the central 50.

22. A system according to claim 17, characterized in that, when the sent subscription is not robust enough to be identified by the central (50), the latter send an order to the cellular (4) for the generation and remittance of another subscription.

23. Television audience measurement system, particularly for the measurement of audience of at least one television set (1), including a medium of detection of change of tuning state (2) of the television set (1), an information processing device, for at least a medium of remittance of subscriptions (4) in the form of a cellular telephone and at least an audience central (50), the audience central (50) continuously registering and recording subscriptions, the system being characterized in that the telephone cellular has processing means and itself acts as a medium of generation of subscriptions (3) and includes operation routines or the like which operate in at least two working procedures, wherein at least one of the procedures includes the following steps:
(i) receiving a response from the audience central (50);
(ii) analyzing the response from the central 50);
(iii) showing the information about the seen channel on the display of the cellular telephone (4) in case the information is recognized;
(iv) instructing the communication from the telephone (4) to the central (50) for the remittance of another information to be recognized.

24. A system according to claim 23, characterized in that the step (iii) is performed in real time.
